(19) United States
(12) Patent Application Publication
(10) Pub. No.: US 2003/0202534 A1
(43) Pub. Date: Oct. 30, 2003

(54) Method and system for adjusting bandwidth in a hybrid-fiber coaxial network using an intelligently controlled dynamic RF combiner

(76) Inventor: Thomas J. Cloonan, Lisle, IL (US)

Correspondence Address: ARRIS INTERNATIONAL, INC, 11450 TECHNOLOGY CIRCLE, DULUTH, GA, 30097, US

(21) Appl. No.: 10/423,501

(22) Filed: Apr. 25, 2003

Related U.S. Application Data
(60) Provisional application No. 60/375,950, filed on Apr. 25, 2002.

(51) Int. Cl. H04J 3/16

(52) U.S. Cl. 370/468; 370/235

(57) ABSTRACT

Relays are set dynamically and automatically in response to subscriber bandwidth demands placed on HFC fiber nodes. Demand is periodically measured for each node served by a CMTS to generate information corresponding to that node's demands. This information is fed back to the CMTS, or a computing system, where it is synthesized with information corresponding to the usage demands of the other nodes. Control signals based on the synthesized information determine the relay settings, thus facilitating the steering of bandwidth to nodes serving subscribers that are collectively demanding higher usage levels than others.

Bandwidth being steered is provided by extra MAC domains not dedicated to a particular fiber node. Combiners combine the extra bandwidth with bandwidth dedicated to a given node; the combined downstream bandwidth is provided to the nodes. Upstream bandwidth is similarly steered so that upstream and downstream channels associated with the same MAC domain are steered together.

### CROSS REFERENCE TO RELATED APPLICATION

This application claims the benefit of priority under 35 U.S.C. 119(e) to the filing date of Cloonan, U.S. provisional patent application No. 60/375,950 entitled “Method and Apparatus for Adjusting the Distribution of Hybrid-fiber Coax Bandwidth Using an Intelligently-controlled, Dynamic RF Combiner”, which was filed Apr. 25, 2002, and is incorporated herein by reference in its entirety.

### FIELD OF THE INVENTION

The present invention relates to network communication systems. More specifically, the present invention relates to intelligently controlling a switching device to dynamically distribute bandwidth among a plurality of virtual network channels.

### BACKGROUND

Multiple System Operators (“MSOs”) and cable TV operators are deploying many new types of services on the hybrid-fiber coax (“HFC”) networks that were previously used only for broadcast video distribution. These new multimedia services include voice, high-speed data, interactive TV and video-on-demand. Many MSOs believe that video-on-demand (or individualized content delivery) is an important service that will generate large revenue streams in the future. The distribution of individualized content delivery (with a different media stream destined for each end user) begs one to consider the use of Internet Protocol (“IP”) to steer the media to its final end-point.

IP may offer several potential benefits over the current method of wrapping MPEG2-encoded packets into MPEG2 Transport Stream Packetsfor distribution over HFC networks. However, while MSOs have been slow to commit to distribution of video over IP on HFC networks, usage of IP as the transport mechanism for video streams is likely to occur when a new video coding standard, such as for example, JVT H.26L, is adopted by the cable industry. Standards, such as PacketCable Multimedia, are even being developed by Cable Television Laboratories, Inc. (“CableLabs”®) that would support video-on-demand services over IP in the future.

Given that this change to a new video coding standard is likely to occur, there is a strong possibility that video over IP will be widely accepted on the HFC plant. As this occurs, the implications of the change from the “broadcast mode” of video-on-demand deployment in use today to the “narrowcast mode” of video-on-demand deployment that is likely to be used in the future should be considered.

In the narrowcast mode, a video-on-demand signal is transported from the head end over the HFC plant to a single subscriber. An efficient way to accomplish this task uses IP packets to carry the video-on-demand signals. The IP packets are passed through a CMTS to be delivered down to the individual subscribers who receive the signals through cable modems, which feed video decoders, which in turn feed analog video to the TVs. These three components (cable modem, decoder, and TV) can be combined in various mixes of integration including set-top boxes with the cable modem and decoder or integrated TVs with cable modem and decoder functionality built in as customer premise equipment (“CPE”). At the network edge, a fiber node is the optical-to-electronic converter box that takes optical signals from the HFC fiber and converts them into electronic signals that are sent out on the cables that deliver service to all subscribers in a particular neighborhood. A single fiber node might typically support between 500 and 2000 homes. In general, and for purposes of discussion, a one-to-one relationship between a fiber node and a neighborhood is presumed. However, it is possible that more than one fiber node can supply service to a neighborhood by splitting subscribers between the multiple fiber nodes. This is known as node splitting.

In the past, data on the HFC typically comprised only Internet traffic and some voice traffic to the subscribers; the data bandwidth variation between the busiest usage period and the lightest usage period was typically small and manageable. As a result, discrete traffic engineering estimates could be used to predict the traffic during the busiest usage periods and the lightest periods, and each fiber node could be assigned adequate bandwidth to support the busy usage period. Under normal operating conditions with light usage, there was “extra” bandwidth on the cable, but the additional cost due to CMTS channels, frequency up-converters, cables, and combiners required to support this “extra” bandwidth was typically minimal.

However, since video content uses a large amount of bandwidth versus voice or standard HTML Internet traffic, when video data is part of the traffic mix on the HFC plant, much wider variations in bandwidth of the data going to a particular fiber node (or neighborhood) tend to occur when compared to the fluctuations that may occur when video is not part of the data traffic mix. For example, Friday evenings may result in up to 30% of the subscribers in a particular neighborhood requesting a unique movie, whereas Wednesday mornings may result in zero subscribers requesting a movie in the same neighborhood. In addition, future Internet traffic (which will include applications such as interactive gaming) may also produce much wider variations on the data bandwidth.

The ultimate deployment of cable data service to businesses will also lead to wider variations on the data bandwidth to business fiber nodes, as most usage will typically occur between 9:00 A.M. and 5:00 P.M. Monday through Friday. Usage other than during the typical working hours will typically occur at residential locations, and thus, the traffic through nodes corresponding to business service will shift to nodes corresponding to residential service. For all of these reasons, traffic variations will be much larger, and the previous technique of providing “extra” bandwidth to accommodate the busy traffic periods becomes much more expensive. The technique of providing enough bandwidth to each fiber node for each fiber node's busy traffic period would lead to staggering costs.

Another technique for accommodating these traffic variations would send the “extra” downstream channels to all of the fiber nodes using the “broadcast mode” of operation. In essence, this approach combines the age-old broadcasting of video signals with the video over IP technology. This approach has several problems. First, since broadcasting is being used, one may wonder what benefits are still provided by the use of video over IP. The complication of adding a cable modem to the set-top box for video may be questionable. In addition, for every data over cable service interface specification (“DOCSIS”) downstream channel to a cable modem that transports data streams, there must exist an upstream channel to allow the cable modem to range, register, and perform periodic station maintenance. Ubiquitous broadcast will therefore be limited by the number of cable modems permitted per upstream channel (usually 125-2000) and by the number of upstream channels permitted per downstream channel, typically four to eight upstream for every downstream channel. Thus, the signal can only be broadcast to a subset of the cable modems in the system.

Additionally, this broadcast mode of operation also suffers from the fact that there may be a limited amount of bandwidth in the downstream spectrum set aside for video-on-demand services. The broadcast mode of operation results in extremely wasteful utilization of the downstream bandwidth, because the bandwidth associated with many different fiber nodes must be transmitted to all fiber nodes, even at times when some of the nodes have relatively few users demanding video traffic.

Finally, the accuracy of traffic engineering models is always a potential source of problems, because changes in subscriber behavior may occur more rapidly than the traffic models can predict, and the required modifications to the CMTS/HFC connections may always lag the subscriber demand.

For all of these reasons, there is a need for a new technique for efficiently distributing narrowcast data services, such as video-on-demand over IP to fiber nodes. This will facilitate only the bandwidth for the narrowcast traffic currently demanded by the subscribers served by a particular fiber node being steered to that node. Moreover, there is a need for a technique for dynamically steering the available bandwidth to accommodate unexpected changes in user bandwidth demands. This technique should permit the bandwidth on the HFC plant to be efficiently utilized, even if extremely wide bandwidth demand variations exist on each fiber node.

### SUMMARY

It is an object to augment the capabilities of existing CMTS equipment by adding an Intelligently-Controlled Dynamic RF Combiner (“ICDRC”) to the CMTS. The ICDRC can be controlled by the CMTS, or another intelligent means, to direct, or steer, enough downstream channels to each fiber node to accommodate the demand for bandwidth on a given fiber node at each instant in time. This steering is intelligently controlled by the CMTS based on different bandwidth requests from each of the plurality of fiber nodes at the network edge.

In the general case, this steering function would occur across more than two fiber nodes. The ICDRC, or other steering means, does not only steer and combine downstream channels, but also steers upstream channels that are associated with a given downstream channel so that the upstream channels arrive at the proper CMTS interface card associated with the downstream channel carrying the data. It will be appreciated by those skilled in the art that a CMTS interface card manages MAC domains and typically comprises physical connections, for example, F connectors, for a plurality if upstream and downstream channels, typically eight upstream channels and one downstream channel. The steering means keeps track of the these channels so that upstream traffic associated with a given downstream channel is always routed to the same CMTS interface card whence the downstream channel originated.

The intelligent steering means periodically monitors the network for bandwidth usage changes in demand from subscribers so that the RF signals on the fiber are combined, or steered, in response thereto by the ICDRC based on the monitored usage and/or demand. In addition, the system can direct cable modems to the appropriate channels that are dynamically steered to each fiber node. The commands for physically steering the cable modem bandwidth are already specified for CMTS systems within the DOCSIS 1.1 and DOCSIS 2.0 specifications. These commands are known as DSx commands, which facilitate the CMTS in instructing cable modems to change the amount of bandwidth to be used on a particular channel, and DCC commands, which facilitate the CMTS in instructing cable modems to change upstream and downstream channels.

With sensing means and methods known in the art, the intelligent steering means can monitor and become cognizant of changes in bandwidth demands at a particular fiber node in several ways. For example, it can obtain this information by analyzing the bandwidth reserved in active service flows on the existing downstream channels being delivered to a fiber node and then ascertain the need for more downstream bandwidth if these reservations exceed a threshold. It can also obtain this information by monitoring (via counts) the actual bandwidth utilization going to a fiber node and then compare that value to a threshold. Another method of detecting the need for more bandwidth is to monitor downstream packets that are dropped due to the actions of congestion control algorithms and/or to monitor upstream bandwidth requests from cable modems that are not getting immediate grants of service. This method works because both of these conditions typically occur when the fiber node is requesting more bandwidth than is available. In an approach that is similar to the PacketCable Multimedia proposal, the intelligent steering means can be instructed of the need for more bandwidth to a fiber node by an application manager, such as, for example, a video server, which is itself cognizant of subscriber requests for service.

Regardless of how the demand for bandwidth is determined, the intelligent steering means, such as, for example, the ICDRC, dynamically responds to demand fluctuations by changing relay and combiner settings in the ICDRC in response to the dynamically determined bandwidth demand. The ICDRC and CMTS can be implemented in one integrated unit or in separate individual chassis that are located proximate one another. The communication between the two sub-systems can take place using methods known in the art, such as, for examples, out-of-band signaling, a separate Ethernet link between the two units, or in-band signaling that would use a cable modem integrated on one or more of the channels within the ICDRC. For a hardened solution, these communication links between the CMTS and ICDRC should be redundant.

### BRIEF DESCRIPTION OF THE DRAWINGS

FIG. 1 illustrates an architectural diagram of a HFC system.

FIG. 2 illustrates a block diagram of a CMTS where the ICDRC is configured for usage levels of a hypothetical scenario at 7:00 on a Friday evening.

FIG. 3 illustrates a block diagram of a CMTS where the ICDRC is configured for usage levels of a hypothetical scenario at 9:00 on a Friday evening.

FIG. 4 illustrates a block diagram that shows downstream components of an IRDC.

FIG. 5 illustrates a block diagram that shows upstream components of an IRDC.

FIG. 6 illustrates a block diagram showing the use of an extra MAC domain to provide backup capabilities when a dedicated MAC domain fails.

FIG. 7 illustrates a flow chart showing steps for intelligently steering bandwidth in a CMTS.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude other embodiments, adaptations, variations, modifications and equivalent arrangements, the present invention being limited only by the claims appended hereto and the equivalents thereof.

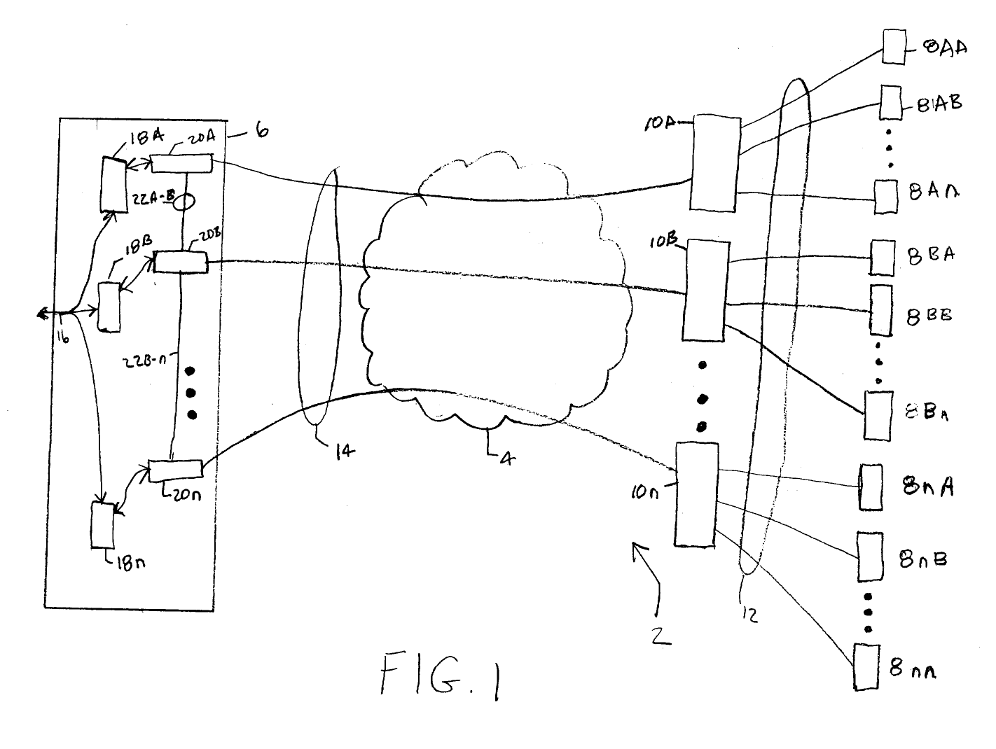

Turning now to the figures, FIG. 1 illustrates a system 2 for transferring data in a broadband network. The network may comprise a fiber network 4 connecting a cable modem termination system head end (“CMTS”) 6 to subscriber cable modems 8AA-8nn. The modems 8 are connected to CMTS 6 through distribution nodes 10A-10n. In a hybrid fiber coaxial system (“HFC”) know in the art, electrical radio frequency (“RF”) signals are typically passed between each of the cable modems 8 and their corresponding nodes 10 via coaxial cable 12. Optical signals are passed between the nodes 10 and the CMTS 6 via optical fiber 14.

At CMTS 6, communication is made with a managed internet protocol (“IP”) network over connection 16 for responding to content requests and providing said content; connection 16 may or may not be implemented over network 4. The CMTS 6 manages a number of media access control (“MAC”) domains, which comprise logical, or virtual channels, for transporting data. Typically, a MAC domain comprises one downstream channel and multiple upstream channels, often eight, such that there are typically nine channels for transporting data between cable modems 8 and CMTS 6 for each MAC domain. These MAC domains may be physically represented by signals created by MAC domain managers 18. The virtual channels can be associated with particular nodes 10 via switching means 20. Furthermore, the switching means 20 may be interconnected by interconnection links 22 such that the virtual channels of one MAC domain can be shared among more than one node 10 or the channels of more than one domain can be directed to only one node.

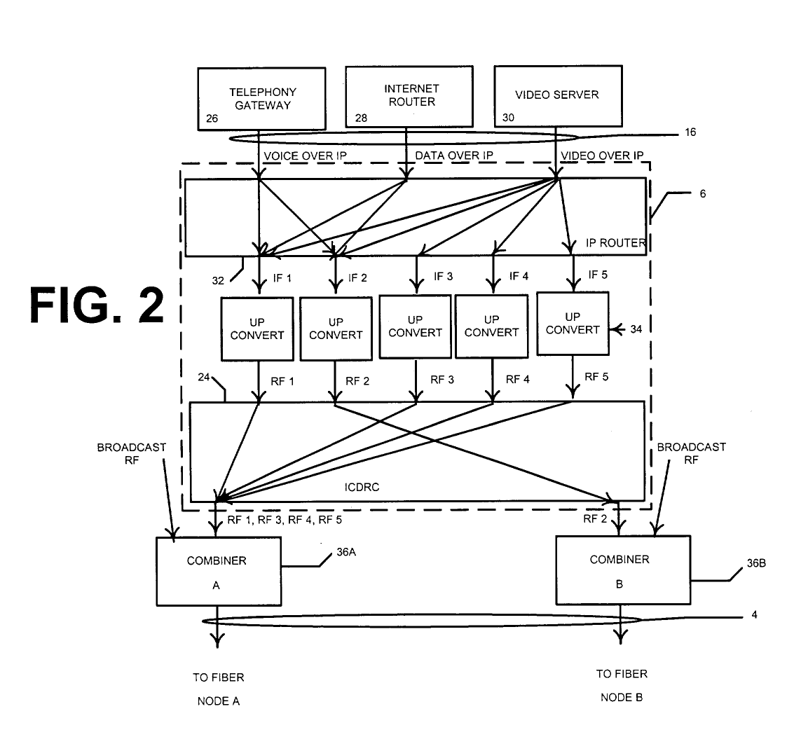

Turning now to FIG. 2, a scenario is illustrated where an intelligently controlled dynamic RF combiner 24 (“ICDRFC”) routes a variety of signal types to two fiber nodes based on usage requirements of the nodes. In a typical broadband network arrangement, multiple services may be provided to a user using IP over IP network 16. This providing of services may be referred to as voice over IP for telephony, data over IP for internet-related usage and video over IP for video programming, the content of each of these services being interfaced with the CMTS 6 by a telephony gateway 26, an internet router 28 or a video server 30, all known in the art. It will be appreciated that CMTS 6 is shown as a dashed line comprising an IP router 32 and up converters 34, the router and converters being known in the art. However it will also be appreciated that the CMTS may not comprise all of these components, the non-comprised components being housed external to, but typically proximate, the CMTS.

The IP router 32 directs intermediate frequency (“IF”) data to upconverters 34, which convert the IP data from intermediate frequencies to RF frequencies. Then, ICDRC 24 steers the upconverted traffic to (and from in the upstream direction) the fiber nodes via combiners 36. In the illustrated example, five upconverters 34 are shown, each corresponding to an intermediate frequency signal from IP router 32 and an upconverted RF signal from respective upconverters. It will be appreciated that the number of upconverters 34 and IF and RF signals may be more or less than five.

IP router 32 produces two IF signals (IF1 and IF2) that are upconverted to the RF frequency spectrum, these signals each represent a MAC domain, and are further shown to be connected respectively to combiner 36A and combiner 36B. Thus, each combiner always receives telephony services and data services, as well as video. However, as shown in the figure, domains 3, 4 and 5 are solely video signals. Moreover, these three video signals are steered through ICDRC 24 to combiner A only. This provides all of the available video bandwidth from domain 1 plus the bandwidth of domains 3, 4 and 5 to combiner 36A. Therefore, if the subscribers connected to node A are collectively demanding a large amount of video bandwidth, and the subscribers connected to node B are collectively demanding a relatively small amount of video bandwidth, the downstream bandwidth available to IRDRC has been efficiently directed to where it is being demanded, without excess video bandwidth being idle and wasted by being directed to node B, which is demanding very little video bandwidth. It will be appreciated that however the bandwidth is steered by the ICDRC, each combiner 36 and node connected thereto will always have a minimal amount of telephony, data and video bandwidth directed thereto.

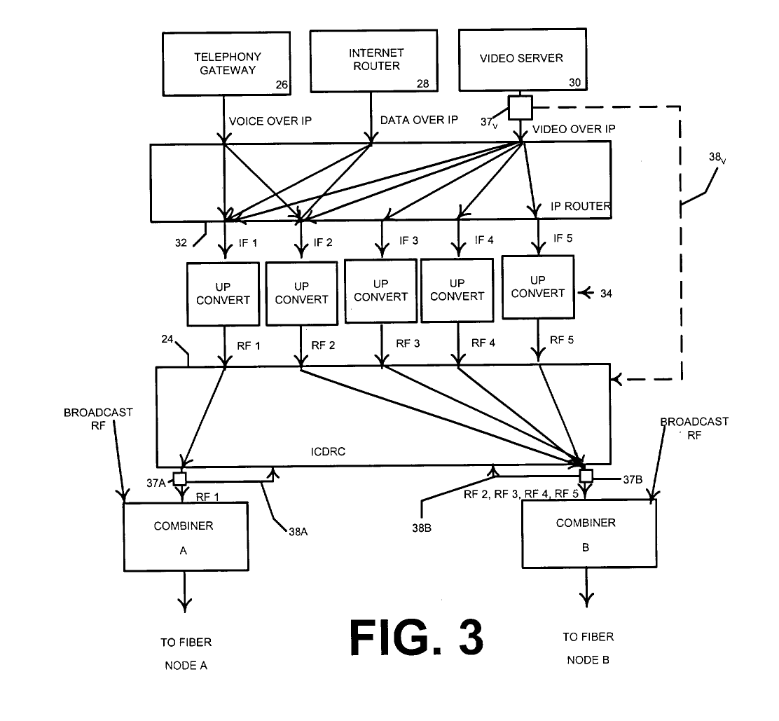

Turning now to FIG. 3, another scenario is illustrated that differs from that illustrated in FIG. 2. Although IP router 32 routes the signals from the telephony gateway 26, the internet router 28 and the video server 30 similarly to that of the routing shown in FIG. 2, the domains are steered differently by ICDRC 24 than is shown in FIG. 2. Instead of domains 3, 4 and 5 being routed to combiner A for forwarding to node A, they are steered to combiner B, for forwarding to node B.

Accordingly, assuming that the scenario shown in FIG. 2 is the steering arrangement at 7:00 P.M. on a Friday night, many of the subscribers that are connected to node A may be, for example, downloading movie programming to be viewed later that evening. Assuming that FIG. 3 shows the steering arrangement at 9:00 P.M. on the same night, the subscribers connected to node A have by-and-large completed their download procedures, or other activities demanding video bandwidth usage, but the subscribers connected to node B are collectively demanding a large amount of bandwidth for downloading video. Thus, ICDRC 24 has steered domains 3, 4 and 5 based on sensed node bandwidth demand, which is sensed by sensing means 37 A and B and fed back into the ICDRC via lines 38A and 38B, respectively shown in FIG. 3, such that the bandwidth available to a given node is intelligently matched with the demands of the subscribers connected to that node. Furthermore, this steering is performed dynamically in response to bandwidth demand sensed by sensing means 37 known in the art. The feedback lines 38A and B are drawn external to ICDRC 24 to illustrate that it is the downstream domain channels, not including any broadcast data, that are typically monitored to determine bandwidth usage demands. However, it will be appreciated that the sensing means 37, as well as the feedback means 38 may be contained internal to the ICDRC 24. It will further be appreciated that the dashed line 38ᵥ represents a sense line for transmitting request-for-bandwidth demand information that has been sensed with bandwidth sensing means 37ᵥ at video server 30. Sensing means 37 includes, for example, analyzing bandwidth reserved in active service flows on the existing downstream channels being delivered to a fiber node and then ascertaining the need for more downstream bandwidth if these reservations exceed a threshold. Other examples of sensing means known in the art include monitoring (via counts) the actual bandwidth utilization going to a fiber node and then comparing that value to a threshold, monitoring downstream packets that are dropped due to the actions of congestion control algorithms, and/or monitoring upstream bandwidth requests from cable modems that are not getting immediate grants of service. When the sensed information is compared to predetermined criteria, the ICDRC 24 makes steering changes based on the results of the comparison. This is done by generating one or more control signals corresponding to a plurality of switching means inside the ICDRC and sending the controls signals thereto, the control signals being changed in response to the control signals so that the steering arrangement of the switching means steers bandwidth according to usage demands.

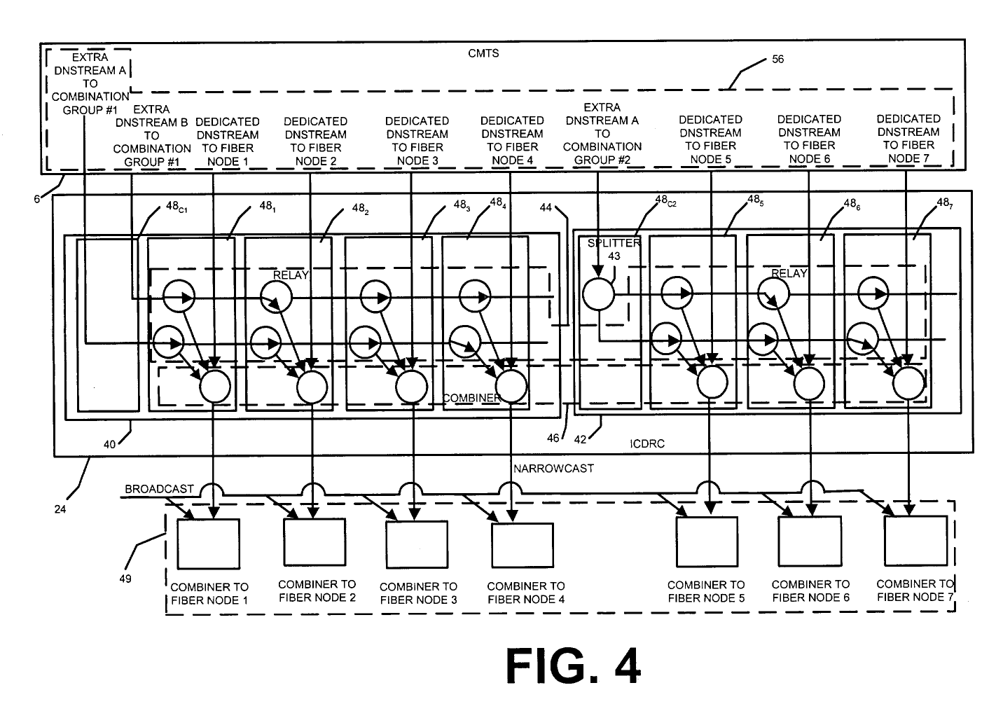

Turning now to FIG. 4, an implementation of the ICDRC is shown. In this example, the ICDRC 24 supports some number of outputs (“X”) that connect directly to the combiners associated with the fiber nodes. Thus, an ICDRC with X outputs will typically be used to supply signals to X fiber nodes—there being typically a one-to-one relationship between each ICDRC output and a fiber node. The seven X outputs shown in the example of ICDRC 24 can be logically sub-divided into a multiple number (“C”) of “combination groups,” where a single combination group is a set of D dedicated downstream channels that will share the bandwidth contained within a set of E extra downstream channels. For example, if C=2, for combination group one 40, D=4 and E=2. For combination group two 42, D=3 and E=1. Thus, it is shown that an ICDRC 24 can contain any number of combination groups, and different combination groups can have different parameters and sizes within a single ICDRC.

Typically, traditional traffic engineering algorithms will be used to determine appropriate combinations of values for D and E. Assuming that each downstream domain channel provides a unit of downstream bandwidth of 30 Mbps in the example, each of the X=4 fiber nodes in combination group one 40 will each be guaranteed 30 Mbps, or 1 bandwidth unit, from their dedicated downstream domain channel and they can share another 60 Mbps, or 2 bandwidth units, from the E=2 extra downstream domain channels. Therefore, there is an average of 180 Mbps/4, or 45 Mbps (1.5 bandwidth units) per downstream channel. However, 90 Mbps, or 3 bandwidth units, could be steered to a single node if subscriber bandwidth usage demanded it.

With respect to combination group two 42, splitter 43 splits the bandwidth unit from extra domain downstream channel corresponding to combination group two, so that 15 Mbps, or 0.5 bandwidth unit, is provided along each relay path emanating from the splitter. The 0.5 bandwidth unit from either, or both, of the relay paths can be steered to any one of the relay circuits associated with a fiber node. The X=3 fiber nodes in combination group two 42 will each be guaranteed 30 Mbps from their dedicated downstream domain channel and they can share another 30 Mbps from the E=1 extra downstream domain channel, so there is an average of 120 Mbps/3, or 40 Mbps (1.33 bandwidth units) per downstream domain channel. However, 30 Mbps could be steered to a single node if subscriber bandwidth usage demanded it, thereby resulting in a total of 60 Mbps, or two bandwidth units, at that node.

In the example shown in FIG. 4, fiber node 1 is being pumped, or provided, with 30 Mbps, fiber node 2 is being pumped with 60 Mbps, fiber node 3 is being pumped with 30 Mbps, fiber node 4 is being pumped with 60 Mbps, fiber node 5 is being pumped with 30 Mbps, fiber node 6 is being pumped with an average of 45 Mbps, and fiber node 7 is being pumped with an average of 45 Mbps (assuming 30 Mbps downstream domain channels). It will be appreciated that fiber nodes 6 and 7 share a single extra downstream bandwidth unit.

The steering configuration shown in FIG. 4 is provided by the settings of each individual relay of the plurality of relays 44 that steer the bandwidth of the extra downstream domain channels to the appropriate combiner circuit or circuits of the plurality of combiner circuits 46 within ICDRC 24. Changing the settings of any of the plurality of relays 44 changes the path of the bandwidth being steered from the extra downstream domain channels to the fiber nodes. Accordingly, based on usage requirements and demands, the bandwidth provided by the extra downstream domain channels can be used where it is needed, and not be wastefully steered for availability at nodes where it is not needed. Moreover, by periodically sensing bandwidth demand of a particular node, the sensed bandwidth usage information, or intelligence, can be fed back to the ICDRC 24. The ICDRC 24 can then use the fed back intelligence to alter the settings of relays 44, thereby dynamically steering the available extra downstream domain bandwidth in response to subscriber demand.

It will be appreciated that two downstream domain channels steered to any one of the plurality of combiners 46 should be centered on different frequencies to avoid interference with one another. In such a scenario, the DOCSIS steering commands discussed above are used to instruct a subscriber's cable modem which frequency should be used for communication with the CMTS 6. These commands also may facilitate node splitting, as discussed above, when two or more nodes, communicating using separate corresponding MAC domain channels at different frequencies share a single fiber from the CMTS such that the cable modems served by a given node are instructed to communicate using the MAC domain channel frequency used for that given node.

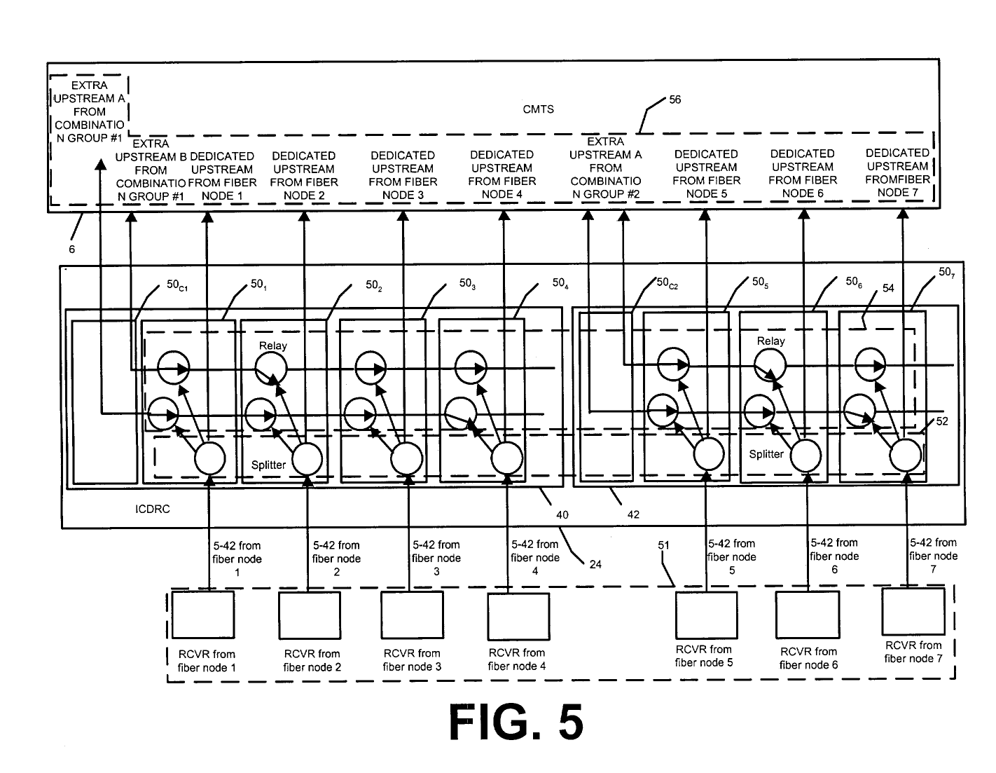

Corresponding upstream configurations corresponding to the downstream configuration are also established, as shown in FIG. 5. The configurations of the upstream domain channels typically mirror the downstream configurations, with the signals being transmitted in the opposite, or upstream, direction. The upstream configuration shown in FIG. 5 corresponds to the downstream configuration shown in FIG. 4. The relay arrangement shown in FIG. 5 splits the 5-42 MHz spectra from each of the upstream channels and steers an appropriate 5-42 MHz spectrum to each of the blades on the CMTS 6. It will be appreciated by those skilled in the art that the relationship between downstream and upstream channels is such that the upstream channels associated with a particular downstream channel are steered to the same blade, or domain circuit, of the CMTS 6 from which that downstream domain channel originates.

FIG. 4 illustrates how the downstream circuitry might be partitioned onto circuit cards 48 in ICDRC 24, and FIG. 5 shows how the upstream circuitry might be partitioned onto circuit cards 50. It will be appreciated that the downstream circuitry for an Nth (N representing any of the circuits cards shown in the figure) circuit card 48 and the upstream circuitry for the Nth circuit card 50 will typically be placed on a single circuit card. Thus, a typical circuit card in ICDRC 24 would have one downstream circuit as shown in card 48 of FIG. 4, and eight upstream circuits as shown in card 50 of FIG. 5. This is true for the cards having relays and splitter or combiners, as well for cards C1 and C2 corresponding to the extra domains for combination groups 1 and 2 respectively. For purposes of clarity, circuits 48 and 50 are shown on separate figures. It will be appreciated that in addition to mechanical relays, the switching means may also comprise silicon or optical switching means.

It should be noted that there may be both combiner channel interface cards and extra channel interface cards for the downstream direction, and corresponding splitter and extra channel interface cards for the upstream direction within ICDRC 24. Combiner interface cards 48₁-48₇ connect to combiners 49 associated with fiber nodes 1-7. There are a total of seven combiner interface cards shown in FIG. 4. Extra channel interface cards 48_{C1} and 48_{C2} accept the extra downstream channels from the CMTS 6 and steer them towards the relays of combiner interface cards 48₁-48₇. In FIG. 5, splitter interface cards 50₁-50₇ interface upstream signals between receiver interfaces 51 that correspond to fiber nodes, and the MAC domain managers 56 of the CMTS 6. Extra channel interface cards 50_{C1} and 50_{C2} accept upstream traffic that has been received and split from upstream traffic by one of the plurality of splitters 52 and routed through one of the relays 54 of the splitter interface cards 50 when said split traffic is being steered to one of the combination group extra upstream MAC domain managers 56 of the CMTS 6.

It should be noted that two different types of extra channel interface cards are shown in FIG. 4. The extra channel interface card 48_{C1} associated with combination group one 40 accepts two downstream channels and returns two 5-42 MHz spectra (one for each downstream channel). The extra channel interface card associated with combination group two 42 accepts one downstream domain channel and splits it, and returns two 5-42 MHz spectra, both associated with the single downstream domain channel.

Other types of extra channel interface cards can also be envisioned. Combiner interface cards may include splitters for splitting the bandwidth dedicated to a particular node so that if the usage demanded of a particular node is much lower than the amount of bandwidth dedicated thereto, then the excess can be steered to other nodes where usage is higher. It is also possible to design a system that daisy-chains more than two downstream and two upstream channels across the circuit cards within a combination group. It will be appreciated that the optimum number of daisy-chained signals will typically be a function of practical bandwidth utilizations, physical design limitations, and signal integrity.

The embodiment shown in FIGS. 4 and 5 does not include redundancy for the data paths. This feature may be added to provide a carrier-class solution with high availabilities. However, if designed with a low failure rate on the circuit cards, the need and cost of redundant data paths may be eliminated.

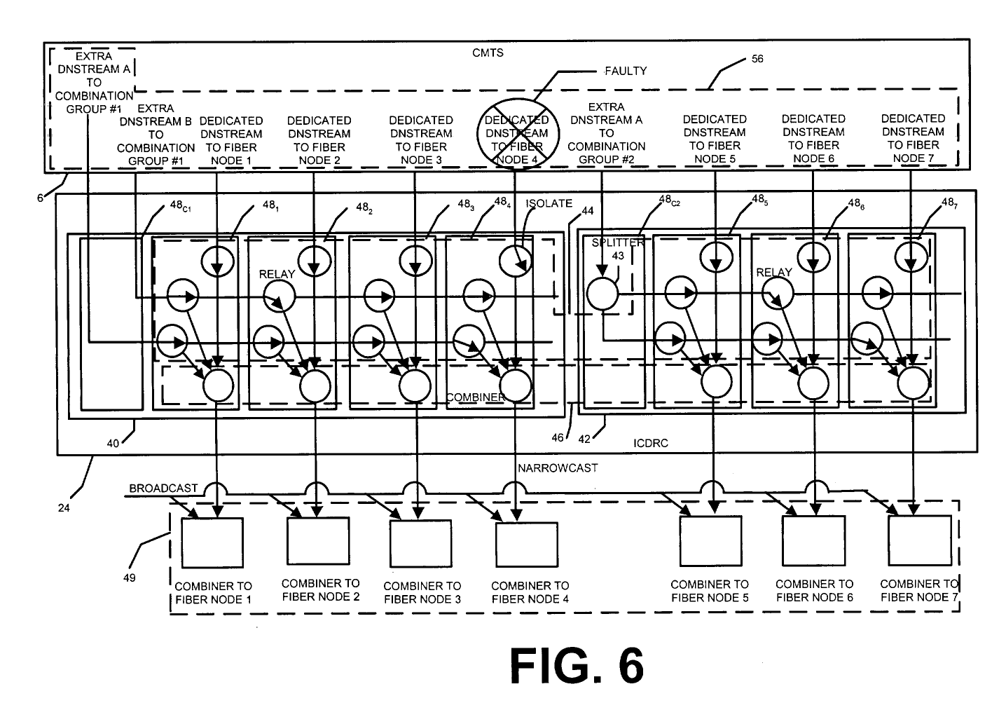

The embodiment shown in FIGS. 4 and 5 does permit redundancy for the MAC domain managers within the CMTS 6. Similar to the example for the downstream direction shown in FIG. 4, FIG. 6 shows that the MAC domain manager 56 associated with the downstream channel dedicated to fiber node 4 is assumed to be faulty and non-operational. When in this state, it is possible that the faulty MAC domain manager is injecting undesirable noise into the downstream channel to which it is attached and unable to transmit data on the channel. To alleviate this problem the CMTS can use techniques similar to those described in U.S. Pat. No. 6,449,249, to Cloonan, et. al., entitled “Spare Circuit Switching” (“the '249 patent”), which is herein incorporated by reference in its entirety.

One of the benefits of the approach described in the present application is the ability for the extra MAC domain to serve as the spare circuit card as described in the '249 patent. When used in this fashion, it is preferred, though not required, that the combination groups described in the present application, or the sparing groups described in the '249 patent, be chosen to be identical. If this is done, the CMTS can detect a faulty MAC domain and can disconnect and isolate the faulty MAC domain manager from the downstream path by appropriately opening the relay 44 connected directly between the MAC domain manager 56 associated with a given node and the combiner 49 associated with said given node. In addition, the other relays 44 would be configured to steer the signal from the extra MAC domain manager 56 of the combination group corresponding to the faulty domain manager to the combiner 46 associated with fiber node 4. When configured in this fashion, the extra MAC domain manager 56 acts as a spare for the faulty MAC domain manager, with the traffic that would have been routed by the CMTS 6 through the faulty MAC domain manager being routed through the spare MAC domain manager. While serving as a spare, the extra MAC domain manager 56 being used as a spare will preferably not be, but could be, used to accommodate bandwidth demands from other fiber nodes.

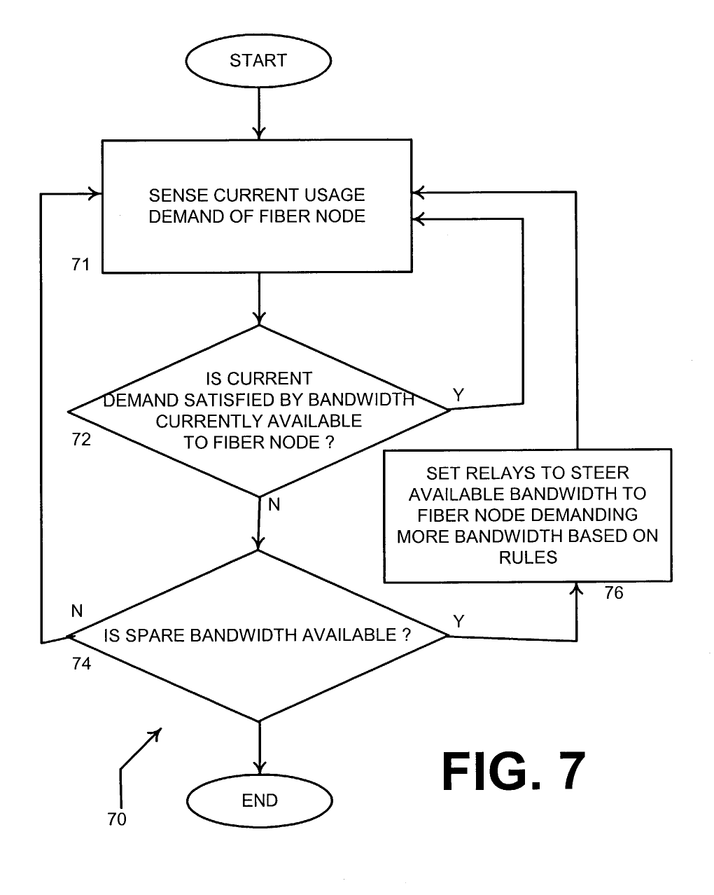

Turning now to FIG. 7, a flow diagram for intelligently steering bandwidth traffic is shown. After beginning routine 70, at step 71 the bandwidth demand/request for a given fiber node is sensed using means known in the art. After the bandwidth is sensed and converted to a data signal, such as, for example, a digital computer signal, the information is analyzed by a computing means known in the art by comparing the sensed information with predetermined criteria at step 72, the criteria being, for example, a bandwidth threshold associated with the node of which the bandwidth information corresponds. If the amount of bandwidth being demanded/requested is currently satisfied by the bandwidth currently available to that node, then routine 70 returns to step 71 and the bandwidth demand/request is sensed/sampled again.

If the criteria at step 72 is not met, however, then at step 74 routine 70 determines whether extra/spare bandwidth is available from an extra MAC domain (i.e. the extra bandwidth is not already being steered to another fiber node). If extra bandwidth is not available, then routine 70 returns to step 71 and the bandwidth is sampled again. If extra bandwidth was determined to be available at step 74, then relays in an IDCRC are set differently than the current settings so that the extra bandwidth is steered to the node requesting/demanding more bandwidth than is being provided to it. After the relay are set, routine 70 returns to sep 71 and the bandwidth is sampled again. The sample rate may be a predetermined rate based on factors, including, but not limited to, the switching speed of the relays, or other switching means, the processor speed of the computing means that compares the sensed bandwidth to the available bandwidth, and other factors known in the art. In addition, the setting of the relays, or other switching means, may be based not only on bandwidth demand versus availability, but other criteria, such as, for example, the collective value of the subscribers served by a particular node relative to the value of the subscribers served by other nodes. For example, if the subscribers served by one node pay a higher amount for service than the subscribers of another node, then a preference for steering of bandwidth can be made in favor of the higher paying subscribers.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

I claim:

1. A system for intelligently steering traffic along a plurality of MAC domains based on bandwidth demand between a central location and a plurality of distribution nodes served by the central location in a communication network comprising:
a plurality of switching means for providing a plurality of changeable data paths for the MAC domains between the central location and the nodes;
a means for determining the data throughput demand(s) of any one or more of the nodes; and
a means for controlling the switching means in response to the throughput demands to change the data paths so that the collective number of bandwidth units of the MAC domains directed to any one of the plurality of nodes corresponds to the data throughput usage demands of that node.

2. The system of claim 1 wherein data paths are dynamically changed in response to the data throughput demands determined by the determining means.

3. The system of claim 1 wherein the switching means includes at least one switch that is controlled by the controlling means.

4. The system of claim 1 wherein the switching means includes at least one combiner for combining a plurality of MAC domains onto one data path corresponding to a single node.

5. The system of claim 1 wherein the switching means includes at least one splitter for splitting one MAC domain among a plurality of data paths corresponding to a plurality of nodes.

6. The system of claim 1 wherein the network is a hybrid fiber coaxial network.

7. The system of claim 1 wherein the nodes are connected to a fiber network and provide electrical RF signals to subscribers.

8. The system of claim 1 wherein each MAC domain includes a downstream channel and one or more associated upstream channels, which are steered together by the switching means so that the data paths of associated downstream and upstream channels of a given MAC domain are steered together.

9. The system of claim 1 further comprising a combiner corresponding to each node for combining one or more broadcast signals with a narrowcast signal, the narrowcast signal being the signal carrying the data associated with one of the plurality of MAC domains.

10. The system of claim 1 wherein each of the switching means includes a connector for outputting the data corresponding to the downstream channel(s) of one or more of the MAC domains, and a plurality of connectors for receiving data corresponding to the upstream channel(s) associated with the one or more downstream channel(s).

11. The system of claim 10 wherein the switching means is a channel interface circuit card.

12. The system of claim 11 wherein each node has a separate channel interface circuit card corresponding thereto.

13. The system of claim 11 wherein a extra channel interface circuit card corresponds to at least one extra domain within a combination group, a combination group being a group of nodes, corresponding channel interface circuit cards and domains associated with one or more extra domains.

14. The system of claim 1 wherein the switching means includes relays for providing the changeable data paths.

15. The system of claim 1 wherein the central location is a CMTS.

16. The system of claim 1 further comprising an isolation switching means corresponding to each fiber node for isolating a faulty MAC domain that is dedicated to a given node so that an extra MAC domain channel can be steered to that node without noise from the faulty MAC domain being steered to said node, the isolation switching means being switch to isolate the faulty MAC domain when the fault is detected.

17. A system for intelligently steering MAC domain channels based on bandwidth demand between a CMTS and a plurality of fiber nodes served by the CMTS in a HFC communication network comprising:
an intelligently controlled dynamic RF combiner for providing a plurality of changeable data paths for the MAC domains between the CMTS and the nodes;
a means for sensing and determining the data throughput demand(s) of any one or more of the nodes; and
a means for controlling the changeable data paths in response to the throughput demands so that the collective number of bandwidth units of the MAC domains directed to any one of the plurality of nodes corresponds to the data throughput usage demands of that node.

18. The system of claim 17 wherein the changeable data paths are formed by remotely controllable relays.

19. The system of claim 17 wherein the means for controlling the changeable data paths includes a computer system for receiving information from the determining means and producing a plurality of control signals, each of the plurality of control signals being used to control one of the changeable data paths.

20. The system of claim 17 wherein the means for controlling the changeable data paths includes a signal conditioner for conditioning the signal produced by the determining means and providing the conditioned signal to the changeable data paths so that the paths are changed in response thereto.

21. The system of claim 17 further comprising an isolation switching means corresponding to each fiber node for isolating a faulty MAC domain that is dedicated to a given node so that an extra MAC domain channel can be steered to that node without noise from the faulty MAC domain being steered to said node, the isolation switching means being switch to isolate the faulty MAC domain when the fault is detected.

22. A system for intelligently steering extra MAC domain channel bandwidth based on bandwidth demand between a CMTS and a plurality of fiber nodes served by the CMTS in a HFC communication network comprising:
an intelligently controlled dynamic RF combiner for providing a plurality of changeable data paths for the extra MAC domains between the CMTS and the nodes;
a means for sensing and determining the data throughput demand(s) of any one or more of the nodes; and
a means for controlling the changeable data paths in response to the throughput demands so that the collective number of bandwidth units of the extra MAC domains directed to any one of the plurality of nodes corresponds to the data throughput usage demands of that node.

23. The system of claim 22 wherein the changeable data paths are formed by remotely controllable relays.

24. The system of claim 22 wherein the means for controlling the changeable data paths includes a computer system for receiving information from the determining means and producing a plurality of control signals, each of the plurality of control signals being used to control one of the changeable data paths.

25. The system of claim 22 wherein the means for controlling the changeable data paths includes a signal conditioner for conditioning the signal produced by the determining means and providing the conditioned signal to the changeable data paths so that the paths are changed in response thereto.

26. The system of claim 22 wherein the intelligently controlled dynamic RF combiner includes combiners for combining downstream domain channel bandwidth dedicated to one of the plurality of nodes with the extra downstream domain channel bandwidth from one of the changeable data paths before the combined bandwidth is forwarded to said fiber node.

27. The system of claim 22 further comprising an isolation switching means corresponding to each fiber node for isolating a faulty MAC domain that is dedicated to a given node so that an extra MAC domain channel can be steered to that node without noise from the faulty MAC domain being steered to said node, the isolation switching means being switch to isolate the faulty MAC domain when the fault is detected.

28. An intelligently controlled dynamic RF combiner for steering extra MAC domain channel bandwidth based on bandwidth demand between a CMTS and a plurality of fiber nodes served by the CMTS in a HFC communication network comprising:
at least one relay for providing a changeable data path for the extra MAC domain channel bandwidth;
at least one combiner for combining the extra MAC domain channel bandwidth from the at least one relay with MAC domain channel bandwidth dedicated to one of the plurality of fiber nodes; and
a means for controlling the at least one relay so that the data path provided thereby directs the extra MAC domain bandwidth to one of the at least one combiners, said combiner being associated with one of the fiber nodes.

29. The intelligently controlled dynamic RF combiner of claim 28 further comprising an isolation switching means corresponding to each fiber node for isolating a faulty MAC domain that is dedicated to a given node so that an extra MAC domain channel can be steered to that node without noise from the faulty MAC domain being steered to said node, the isolation switching means being switch to isolate the faulty MAC domain when the fault is detected.

30. A method for intelligently steering the bandwidth of an extra MAC domain channel to one or more of a plurality of fiber nodes in an HFC communication network such that greater bandwidth is provided to the node or nodes to which the extra bandwidth is steered than the bandwidth amount that is dedicated to said node or nodes, comprising:
periodically determining the bandwidth demand of each of the nodes;
for each of the nodes, comparing the determined bandwidth demand with predetermined criteria and generating a data signal corresponding to the comparison;
determining whether extra bandwidth is available based on comparisons of current usage demands and bandwidth steering configurations for the other nodes; and
configuring a steering means to provide a data path for directing the extra bandwidth to one or more of the nodes based on the periodically determined bandwidth of the nodes.

31. the method of claim 30 further comprising combining the steered extra bandwidth with bandwidth of a MAC domain dedicated to the node to which the extra bandwidth is being directed.
